(19) United States
(12) Patent Application Publication
(10) Pub. No.: US 2025/0026095 A1
(43) Pub. Date: Jan. 23, 2025

(54) ROTARY DEVICE FOR PRODUCING SHOE SOLES USING A CENTRAL RIG WITH 360 DEGREE MOVEMENT AND FREEDOM OF MANUAL SECTORIAL MOVEMENT

(71) Applicants: Jalal Mirdavoodi, Antalya (TR); Aghil Nazari Barsari, Antalya (TR)

(72) Inventor: Aghil Nazari Barsari, Tehran (IR)

(21) Appl. No.: 18/715,718

(22) PCT Filed: Dec. 8, 2021
(86) PCT No.: PCT/IB2021/061455

§ 371 Date: Jul. 1, 2024

(51) Int. Cl. B29D 35/00; B29D 35/12

(52) U.S. Cl. CPC B29D 35/0018; B29D 35/122

(57) ABSTRACT

The invention of rotary device for producing shoe soles using a central rig with 360 degree movement and freedom of manual sectorial movement relates to the field of polyurethane injection machines and the optimization of 360 degree injection machines in the industry of manufacturing PU soles, men's and women's slippers, sandals and shoes. In the present invention, the raw materials are poured into a double-walled tank and possible moisture is absorbed by dehumidification filters; The materials are then mixed together by a mixer, the amount of mixing of the materials is also controlled and adjusted by the monitor; After mixing, the material is directed to the pouring head and poured into the mold; Then, after filling a mold, the next station is identified by the shaft and encoder and the rig moves to the next station.

### TECHNICAL FIELD OF INVENTION

The present invention relates to the field of polyurethane injection machines and the optimization of 360 degree injection machines in the industry of manufacturing PU soles, men's and women's slippers, sandals and shoes.

### PRIOR ARTS

In the previous inventions, the hand injection machine was made in Italy to produce all kinds of footgear, shoe soles and slippers with polyurethane soles. The rig of this machine was designed on the side (right side) and up to 24 stations to molding and arranging in front of it. In the past, this device changed the rotation angle to 240 degrees by changing the base of the rig, allowing 36 stations to be arranged. But after years, by increasing in the length of the device rig, it was possible to build larger devices with a capacity of up to 48 stations around the device. This machine was very economical and justifiable from the manufacturers' point of view but unfortunately the big drawback of these devices was that they took up a lot of space, so that it could not be installed in halls under 14 meters wide, and as a result, not all shoe manufacturers could use it in small halls.

A U.S. Pat. No. 2,909,807A titled “Automatic rotatory type machine for making shoes or boots rubber-soled with heat and compression” is a device to produce leather shoes with rubber cover including rotatable table, a unit that is placed at regular intervals on the table, a loading platform that is normally placed relative to the table, hydraulic tools using flanges to automatic effect on alternating rotation of the table and to place each unit next to the material filling platform.

A Chinese patent No. CN104886880A which is filed on 22 May 2015 titled “Circular-disc rubber and polyurethane double-density upper-integrated shoe sole forming assembly line and machining method thereof” relates to a circular-disc rubber and polyurethane double-density upper-integrated shoe sole forming assembly line and a machining method thereof. The assembly line comprises a circular disc, an outsole rubber injection machine, an insole polyurethane injection machine, a circular disc drive mechanism and automatic shoe manufacturing machines. The upper end of the circular disc is provided with the outsole rubber injection machine and the insole polyurethane injection machine in the radial direction at an interval. The injection direction of both the outsole rubber injection machine and the insole polyurethane injection machine is the radial outer end of the circular disc. The periphery of the circular disc is provided with a plurality of automatic shoe manufacturing machines. The circular disc drive mechanism can drive the circular disc to rotate by 360 degrees. The difference between the mentioned invention and the proposed invention is that in the mentioned invention the material injection rig is fixed and has no rotation instead, the plate on which the molds (shoe making machine) are placed rotates, but in the presented invention, the material injection rig is located in the center and has the freedom of movement to the sides and has the ability to rotate 360 to inject polyurethane materials into the molds.

A Chinese patent No. CN2738988Y which is granted on Sep. 11, 2005 titled “Fully-automatic plastic-sole jet-forming machine” relates to the technical field of shoe making mechanical, in particular to a fully automatic plastic sole jet-forming machine. This invention comprises a shot material base equipped on an engine base and a station rotating platform, at least two shot material pipes are communicated on the shot material base, which is connected with different feed inlets. The shot material head is equipped with injection ports separately corresponding to the shot material pipe, and the shot material base is movably structural connection between the engine bases. The mold equipped on the station rotating platform comprises a socket and at least two upper caps which are connected with the socket by hinging. The top cap is equipped with an input port for the injection port. As mentioned above, in the mentioned invention, the plate on which the mold is placed is rotating and the material injection base, from which at least two material injection tubes come out, is fixed in one part, so it is different with the claiming invention.

A Chinese patent No. CN102765206A which is granted on Oct. 15, 2014 titled “System for making shoes automatically from polyurethane” relates to a system for making shoes automatically from polyurethane, comprising casting machines and a plurality of automatic shoe making machines. The casting machines are coaxially and movably arranged on two parallel guide rails in a guiding way; the juxtaposed automatic shoe making machines are arranged in parallel on one side of the two parallel guide rails in the moving direction of the casting machines; a conveying gear belt is coaxially arranged between the two parallel guide rails; and a transmitting gear which is driven by a motor and engaged with the conveying gear belt is arranged on the lower part of the casting machine. This injector is packed in the storage tank on the cast pedestal through pipeline connection; Injector can upper and lowerly be moved by hydraulic oil cylinder driving, and the horizontal displacement of governor motion adjusting injector along the cast arm is installed on the cast arm, and present embodiment adopts the pinion and-rack position adjusting mechanism.

A Chinese patent No. CN104742399A which is granted on Aug. 2, 2017 titled “Mechanism for filling polyurethane into upper” is a mechanism for filling polyurethane into an upper. The mechanism comprises a pouring machine and a moving mechanism, wherein the moving mechanism comprises a moving trolley and a pouring arm positioned at the upper part of the moving trolley and extending outwards transversely, the pouring arm can expand transversely, the pouring machine is arranged on the moving trolley, the injection nose of the pouring machine is arranged at the front end of the pouring arm, and a shoes making machine is arranged under the injection nose; the moving mechanism also comprises a driving mechanism for driving the pouring arm to tilt; and the driving mechanism comprises a threaded rod which can lift through meshing of internal and external threads, a driven bevel gear for driving the internal thread to rotate, and a supporting rod for limiting the rotation of the threaded rod. Therefore, the general movement of this device is transverse on the rails installed on the ground.

An European patent No. EP2124662B1 which is granted on Nov. 28, 2012 titled “Insole sole upper shoe and manufacturing methods thereof” described an insole, a sole, an upper, a shoe and the manufacturing methods thereof, wherein an elastic member, preferably of thixotropic polyurethane, is applied to a support of the insole, the sole or the upper A manufacturing method for an insole according to any one of the preceding claims, comprising the application of at least one elastic member on the under surface of a support of the insole, having a different hardness from that of the supporting part of the insole characterized in that said elastic member is poured in the semi-fluid state onto the support of the insole and left to polymerize so as to solidify and expand in thickness. Subsequently, the form is overturned and lowered towards the mould provided with at least one injection or pouring nozzle. In this manner the lower part of the upper and thus also the elastic member are situated inside the mould. Lastly, the plastic material, such as PU is injected or poured from the nozzle into the mould to form the sole which adheres to the upper. In this invention the rig on which the injection nozzle is placed, is transverse and there is no rotation in it.

An US patent No. U.S. Pat. No. 3,555,609A which is granted on Jan. 19, 1971 titled “Injection molding apparatus” provides an injection molding apparatus having a plurality of molding units embodying a sole mold movable. The present invention relates to an injection molding apparatus and, more particularly, to a plurality of identical but independent molding units mounted upon a rotatable work table operative to bring the molding units in turn into association with injection molding apparatus. In the known injection machines in which molding material is injected to form a sole onto a lasted upper, production is slowed due to the necessity of awaiting the cooling and setting of the injected molding material before the upper can be removed from the last and a new upper mounted on the last. This dela for cooling and setting is overcome by the present apparatus by the provision of a plurality of molding units mounted on a rotatable turntable whereby operators work on some molding units as injection is effected on other units and cooling achieved during the movement between the stations.

An US patent No. U.S. Pat. No. 3,709,973A which is granted on Sep. 1, 1973 titled “Manufacture of footwear and/or components thereof by injection molding of synthetic resinous material or other molding materials” relates to a shaping of an insole and the production of an article of footwear in which an insole blank is positioned on a last member and pressed there against by a first closure member for conforming the insole blank to the shape of the last member. A first molding material is injected into a first molding cavity provided between the insole and the first closure member and an upper is lasted onto the insole carrying last. A second molding material is injected into a second molding cavity provided by a second closure member positioned adjacent the last member. Since several stages of injection are done to make different parts of shoes in this invention and each of them needs its own mold, each of these molds (manufacturing steps) is placed on a rotating table and rotated by it. Also the injection stations can be changed.

An US patent No. U.S. Pat. No. 3,915,608A which is granted on Oct. 28, 1975 titled “Injection molding machine for multi-layered shoe soles” is an injection molding machine for producing shoe soles includes a fixed base, a turntable for rotation relative to the base between a plurality of stations, a plurality of molds including a mold piston and mold sides mounted on the turntable, the number of molds being equal to the number of stations, a multi-faceted column extending upwardly from and being rotatable with the turntable, and a last holder mounted on each face of the column, the number of last holders being equal to the number of molds. A dummy last is mounted on one side of the last holder for closing the mold by defining a first mold cavity with the mold sides and piston for molding a first sole portion at a first molding station, and a last is mounted on each of two opposing faces of the last holder adjacent the dummy last for receiving uppers and closing a mold defined by the mold sides, mold piston and first sole portion to mold a second sole portion between the first sole portion and the lasted upper at another molding station opposite the first molding station.

### DESCRIPTION OF THE INVENTION

The present invention is an automatic polyurethane injection machine that can be rotated 360 degrees by placing the injection rig in the center of the system and can deploy up to 48 stations in a small environment, also reduced the amount of force required to move to the sides to fill the mold.

In this invention to eliminate the high force to move the shaft of the device to the sides during injection, by creating rabbet joint in the rig and the shaft, the desired force to move to the sides is reduced.

### Description of Operation of the Device:

First, the raw materials are poured into a double-walled tank, the temperature of which is controlled by thermostats connected to the tank and the central computer, and in order to absorb possible moisture, dehumidifier filters containing silica gel are installed inside the tanks. These tanks are also equipped with a material filling pump and a level gauge.

The pane of the machine main controlling panel is equipped with an advanced color monitor that the production process can be controlled from the monitor. All applications of the device are programmed by the PLC software system and can be seen by the operator on the monitor.

After adjusting the amount of mixing material on the monitor, the required material and paint are transferred from inside the tank to the mixer. The mixing unit consists of a double-walled tank with its own mixer and a separate electrical panel for mixing PU (polyol) materials, and it can also be used as a spare tank for polyol materials.

In this device the detection of stations is done by shaft and encoder and the rig positioned in the center of the device and there is possibility to install 12 to 48 stations.

The device contains a pouring material head into the mold which lead the material to this head after mixing to pour the material into the mold which the amount of required is controlled and adjusted on the monitor. Also this device includes a methylene chloride tank to wash the top of the head.

The injection stations of this device equipped with a pneumatics system (pneumatics jack) which the inhibiter force of the jack is 4000 N.

The system with a spray tank made of silicone oil is used to spray the mold.

The presence of the engine in the rig and also the location of the rig in the reel create freedom of movement so that the rig moves automatically after filling the mold in a station. The next station is identified by the shaft and the encoder and the rig is locked on the next station after moving. After the rig is locked, by considering the rabbet joint tab on the rig and the shaft, the shaft can move halfway to the sides and the operator can move the shaft sideways to fill the mold by applying a slight force.

### DESCRIPTION OF DRAWINGS

FIG. 1: Total three dimensional image of the device.

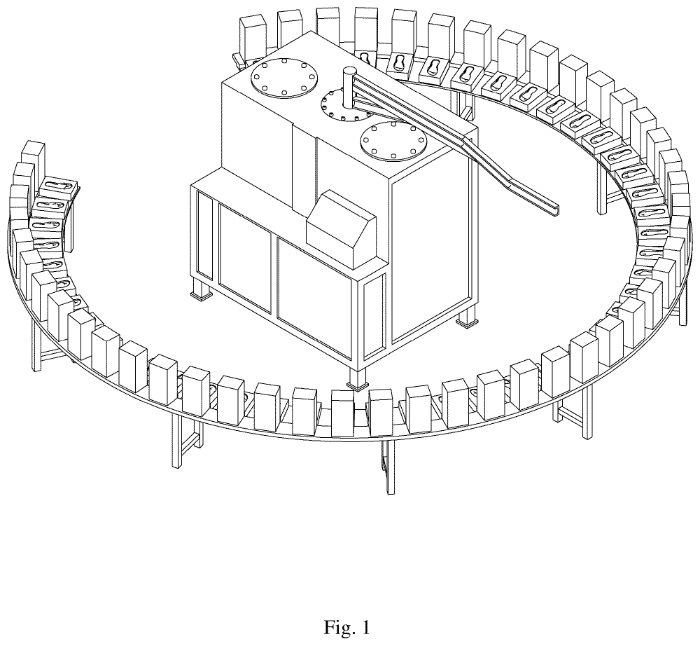

FIG. 2: Front view and total view of the device.

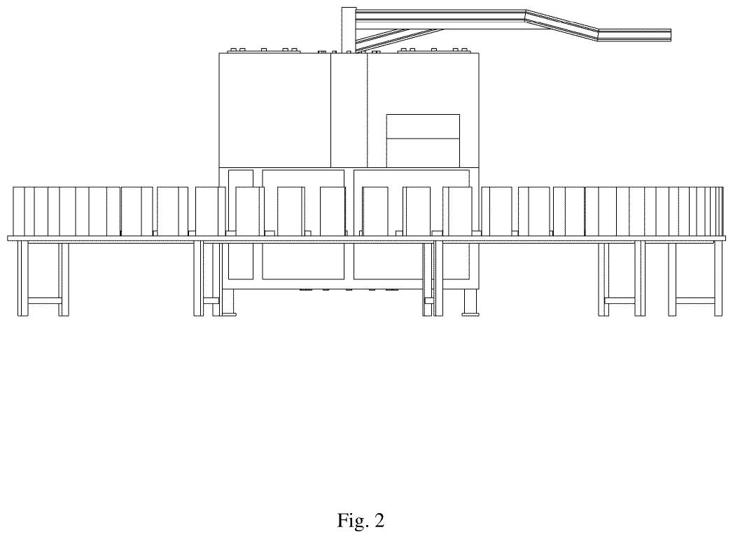

FIG. 3: Top and total view of the device.

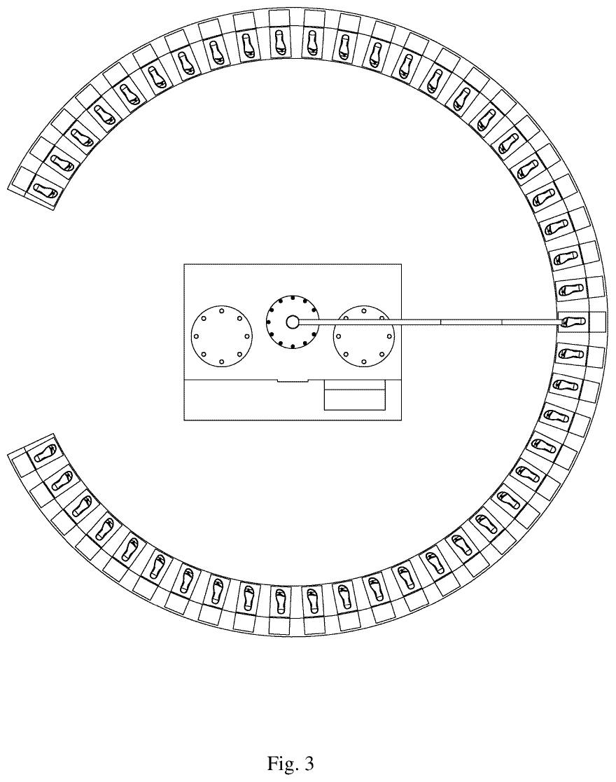

FIG. 4: Three dimensional image of rig and shafts and related equipments.

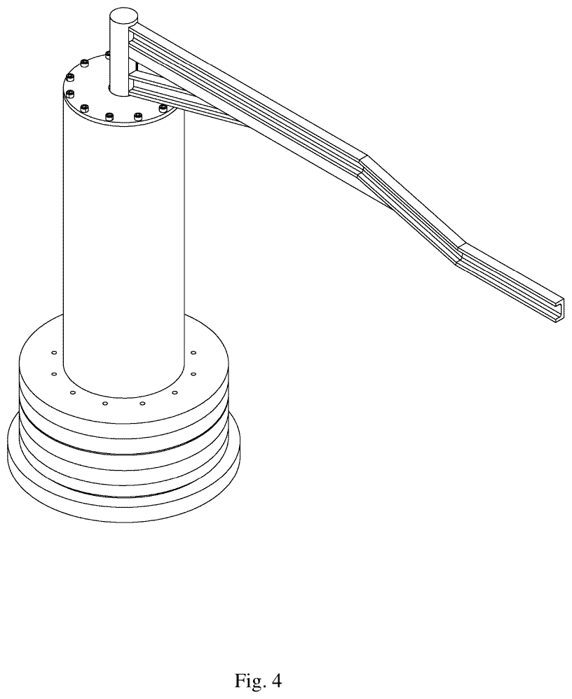

FIG. 5: Cropped image from front view of rig and shaft and related equipments.

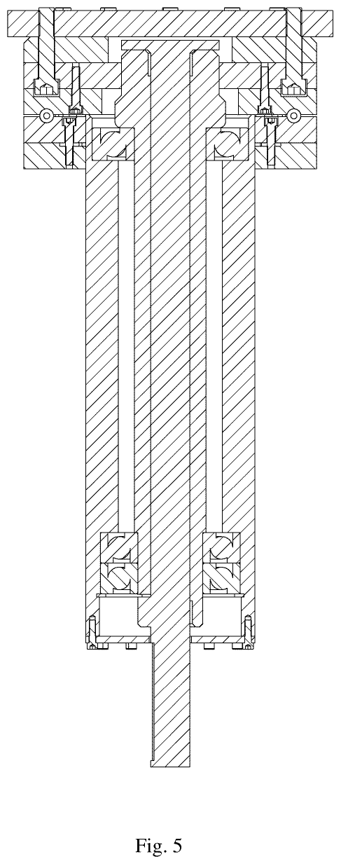

FIG. 6: Three-dimensional image of rabbet joint of rig and shaft.

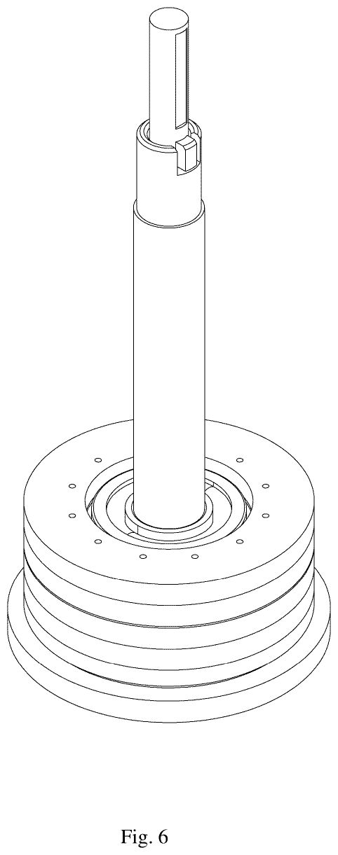

FIG. 7: Front view of rabbet joint of rig and shaft.

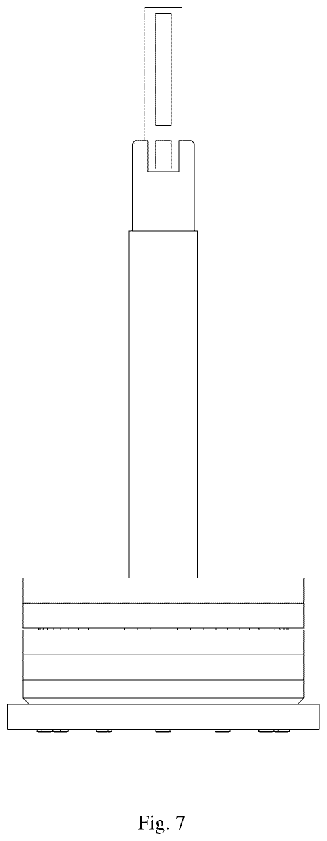

### ADVANTAGES OF INVENTION

In the present invention, the material injection pump uses a servo motor that generates reciprocating motion, which can move the head of the device with less force, and thus the operator's energy can be spent on the required tasks in production process.

What is claimed is:

1. The invention of rotary device for producing shoe soles using a central rig with 360 degree movement and freedom of manual sectorial movement contains at least 48 injection stations, at least one rabbet joint in rig and shaft, at least one double-walled tanker, at least one thermostat connected to the tank, at least one dehumidifier containing silica gel, at least one filler pump and at least one level gauge, at least one controlling panel which is equipped with a color monitor, at least one mixer, at least one pouring head, at least one tank containing methylene chloride, at least one pneumatic system and at least one silicone oil spray system.

2. The automatic polyurethane injection machine of claim one in which the raw materials are poured into a double-walled tank and possible moisture is absorbed by dehumidification filters; The materials are then mixed together by a mixer, the amount of mixing of the materials is also controlled and adjusted by the monitor; After mixing, the material is directed to the pouring head and poured into the mold; Then, after filling a mold, the next station is identified by the shaft and encoder and the rig moves to the next station.

3. The automatic polyurethane injection machine of claim one in which there is possibility to install 48 stations.

4. The automatic polyurethane injection machine of claim one in which to eliminate the high force to move the shaft to the sides during injection, a rabbet joint is used in the rig and the shaft.

5. The automatic polyurethane injection machine of claim one in which the detection of stations is done by shaft and encoder and the rig is locked on the next station after moving.

6. The automatic polyurethane injection machine of claim one in which there is double-walled tank which the raw materials are poured into them.

7. The automatic polyurethane injection machine of claim one in which the existed tank is equipped with thermostats that is controlled by the central computer.

8. The automatic polyurethane injection machine of claim one in which the tanks are equipped with a dehumidifier filters containing silica gel in order to absorb possible moisture.

9. The automatic polyurethane injection machine of claim one in which tanks are equipped with a material filling pump and a level gauge.

10. The automatic polyurethane injection machine of claim one in which the production process is controlled by main controlling panel of the device that is equipped with color monitor.

11. The automatic polyurethane injection machine of claim one in which the device contains a mixer, which consists of a special tank and mixer for mixing polyol materials.

12. The automatic polyurethane injection machine of claim one in which device contains a pouring material head into the mold.

13. The automatic polyurethane injection machine of claim one in which there is a methylene chloride tank to wash the top of the head.

14. The automatic polyurethane injection machine of claim one in which the injection stations are equipped with a pneumatics jack which the inhibiter force of it is 4000 N.

15. The automatic polyurethane injection machine of claim one in which a system with a spray tank made of silicone oil is used to spray the mold.
